(19) United States
(12) Patent Application Publication
(10) Pub. No.: US 2011/0277741 A1
(43) Pub. Date: Nov. 17, 2011

(54) OVEN, ESPECIALLY DOMESTIC OVEN

(75) Inventors: Marco Böckler, Rothenburg (DE); Tobias Weber, Burk (DE); Erhardt Koitzsch, Rothenburg (DE); Klaus Winkelmann, Gedern (DE); Gerhard Münzberg, Obstadeln (CH); Mirko Gummersbach, Olpe-Dahl (DE)

(73) Assignee: ELECTROLUX HOME PRODUCTS CORPORATION N.V., Brussels (DE)

(21) Appl. No.: 13/129,693

(22) PCT Filed: Nov. 18, 2009
(86) PCT No.: PCT/EP2009/008222

§ 371 Date: Aug. 3, 2011

(30) Foreign Application Priority Data
Nov. 18, 2008 (EP) 08020063.7

(51) Int. Cl. A21B 1/00

(52) U.S. Cl. 126/273 R

(57) ABSTRACT

An oven, especially a domestic oven, can comprise a cooking cavity and at least two carrier structures arranged at each side of the cavity respectively for holding an auxiliary element for cooking food, wherein each carrier structure comprises at least one column extending in a vertical direction (V) within the cavity, and at least one holding element for holding the auxiliary element. The holding element is moveable along at least a sliding range of the column or columns in the vertical direction (V) in a sliding movement, so that the holding element is adjustable in its vertical (V) height within the cavity. And, the columns and the corresponding holding elements comprise corresponding guiding surfaces each extending in the vertical direction (V) and are in contact with each other during the sliding movement so that, during the sliding movement, the holding element is guided by the column or columns.

The invention relates to an oven, especially to a domestic oven.

For different purposes domestic ovens of this kind are equipped with auxiliary elements, especially baking trays or grilling grids, which can be placed in the cavity at different vertical heights to define cooking levels. The ovens often have a carrier structure at each side of the cavity on which an auxiliary element can be placed. For example, such carrier structure can comprise a plurality of grooves at different heights machined into the sides of the cavity or a grid-like structure with two vertical columns and several horizontal holding elements at different heights, wherein the auxiliary element can be inserted into opposite grooves or onto opposite holding elements arranged at the same height to place the auxiliary element at this height within the cavity. The holding elements themselves can be constituted by simple horizontal rods or also by horizontal extraction elements such as telescopic runners with one element fixed to the columns and one or two further elements horizontally and linearly moveable with respect to the other element(s).

There are known carrier structures for auxiliary elements where the holding elements are releasably mounted to the columns of the carrier structure and can be taken off the columns completely and mounted or fixed again at a different vertical height by releasable connection means such as hook and slit connections arranged at different heights, so that the height can be adjusted to and selected between several discrete height positions within the cavity. Examples for such solutions are disclosed in KR 2007018449 A, in DE 36 28 763 A1, in DE 20 2007 006 386 U1, in DE 20 2004 002 065 U1, in U.S. Pat. No. 5,429,043 and in DE 10 2006 015 444 A1.

It is an object of the invention to propose an oven which allows a vertical adjustment of an auxiliary element, such as a tray or grid.

A solution of this object according to the invention is suggested by the features of claim 1. Specific embodiments and improvements can be obtained from the dependent claims.

The oven, especially domestic oven, according to claim 1, comprises a cooking cavity (or: oven muffle) and at least two carrier structures each arranged on a different side of the cavity and being provided for holding an auxiliary element, in particular a tray e.g. a baking tray, or a grid, in particular a grilling grid, for cooking goods, in particular food, wherein each carrier structure comprises at least one column (or: vertical rod, rail, track, carrier element), preferably at least two columns, extending in a vertical direction within the cavity and at least one holding element for holding the auxiliary element. Each holding element is moveable (or: displaceable or slideable) along at least a part or sliding range of the or each column in the vertical direction in a sliding movement, so that the holding element is adjustable in its vertical height within the cavity.

In order to guide the holding element during the sliding movement by or along the column each column and the corresponding holding element preferably comprise vertically extending guiding surfaces (or: sliding surfaces) corresponding to each other and being in (sliding) contact with each other during the sliding movement.

By this guidance there is preferably also a shape-locking connecting in the horizontal direction between the holding element and the corresponding columns.

Preferably, the holding element during the sliding movement or also in a fixed or adjusted vertical position is fixed in horizontal direction or remains at the same horizontal position with respect to or relative to the column(s) and is only moved vertically relative to the column(s), as it stays at the column(s) and is not taken off or displaced with a component or partial vector in horizontal direction.

By this new solution according to the invention the user, in order to bring the auxiliary element to another cooking level within the cavity, does not have to take off the holding elements from the columns of the carrier structures. Rather, during adjustment of the vertical height of the holding elements within the cavity, the holding elements can stay or remain at the columns, without falling off also, and can simply be slid vertically up-ward or downward in order to reach a different vertical height. There are also no releasable connection parts needed any more to connect the holding elements with the columns, in particular no protruding parts such as hooks or slits or holes which can get deformed or covered with dirt.

According to another aspect, which can be combined with any other feature or combination of features described herein, the invention relates to an oven, especially to a domestic oven, having a cooking cavity, wherein a carrier structure is arranged at each side of the cavity for receiving and/or holding an auxiliary element and wherein the carrier structure comprises a frame element having at least one vertical extending column on which a holding element is arranged adjustable in its vertical height relatively to the column.

According to one embodiment the holding element can be fixed at each vertical position within the sliding range continuously by providing sufficient gripping or sliding resistance or, more safely by providing continuous fixation means such as gripping or clamping means at the holding element cooperating with at least one of the columns, in particular at the guiding surface of the column, which continuous fixation means can be released from the column(s) for allowing for the sliding movement and be fixed again when the sliding movement is over and the new vertical height is reached. According to another embodiment the holding element can be fixed at several different vertical positions within the sliding range which positions are discrete or arranged at a distance from each other by providing stopping or positioning means which have at least one corresponding stopping or positioning element provided at least one of the columns at each of these different vertical positions. These positioning means can comprise gripping means or clamping means or snapping means which can be released or the fixation of which can be reversibly overcome by applying a force above a certain holding threshold force for allowing for the sliding movement and be fixed again when the sliding movement is over and the new vertical position is reached.

Such positioning means can e.g. comprise recesses in the column(s) at the different heights and a corresponding protruding part at the holding element snapping or engaging into the corresponding recess at a specified vertical position when the holding element during its vertical sliding movement reaches this specified vertical position.

In other words, the at least one column can have a plurality of indexed positions in different vertical heights for the holding element. By those indexed positions it becomes possible to adjust the holding element on both sides of the cavity in exactly the same height in an easy manner.

Preferably the carrier structure has two columns and in particular two connection rods, which connect the two columns outside the sliding range in particular in a closed loop and/or as a frame element.

The holding element usually extends in a substantially horizontal direction. The holding elements themselves can be constituted by simple horizontal rods or rails or tracks or, alternatively, also by horizontal extraction elements such as telescopic runners or telescopic elements with one element fixed to the columns in a slideable manner and one or two further elements horizontally and linearly moveable (usually in linear sliding or roller bearings) with respect to the other element(s).

The shapes of the guiding surfaces which are in sliding contact with each other can be selected from a wide variety of shapes, but should be such that a proper guiding is achieved and that the holding elements do not fall off the corresponding columns in horizontal direction or in other words as long as the guiding surfaces provide some shape-locking connection between holding element and column(s) in a horizontal direction and allow for vertical sliding movement. Preferably the or each guiding surface has a constant shape in its horizontal cross section at least along the sliding range.

Preferably two corresponding guiding surfaces at column and holding element have congruent or corresponding shapes in horizontal cross section, the column(s) at least along the sliding range, in particular along basically the whole height.

In another variant two corresponding guiding surfaces at column and holding element are arranged coaxially in vertical direction and/or are formed as closed surfaces or with closed contours in horizontal cross section, in particular a circular shape in horizontal cross section or a cylindrical shape as a whole, the guiding surfaces thus completely surrounding or encircling each other wherein in particular the guiding surfaces of the holding elements are outside of the guiding surface of the column(s), in particular the holding elements providing a passage for the column.

In a further variant, two corresponding guiding surfaces at column and holding element are formed as open surfaces or with open contours in horizontal cross section, in particular open contours allowing for a shape-locked connection in horizontal direction such as T-shape or wedge-shape or drop-shape or the like.

The holding element comprises in a further embodiment at least one grip element which is fixed at the holding element and which has a bore for the passage of the column. Preferably, the bore and the column have congruent forms in a horizontal cross section.

In a preferred embodiment the sliding range for the sliding movement of the holding element relative to the column(s) covers at least two, in particular all, predefined cooking levels within the cavity. Cooking levels within the cavity are usually defined to provide a corresponding heat and/or air distribution for cooking goods arranged on an auxiliary element at this specified cooking level. These cooking levels are often also parameters for the control of the oven or the instructions to the user, e.g. in a user manual, in particular for preselected or selectable cooking programmes. The cooking levels correspond to specific vertical heights in the cavity.

In the drawings exemplary embodiments of the invention are depicted.

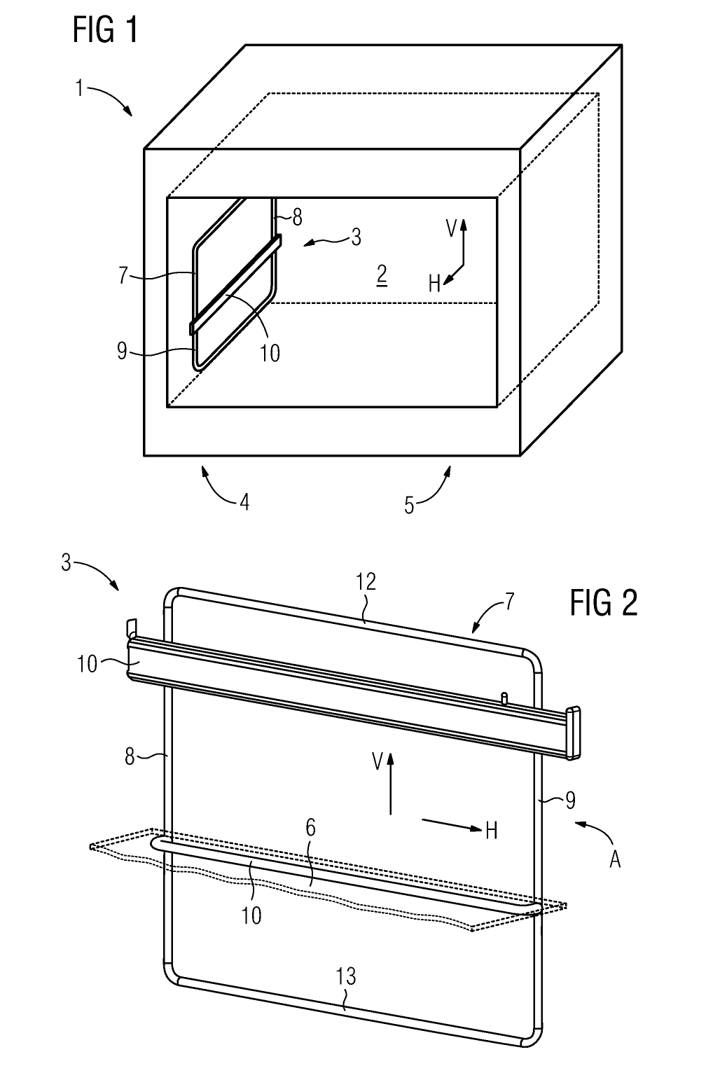

FIG. 1 shows schematically in perspective view a domestic oven with an oven cavity,

FIG. 2 shows in perspective view a carrier structure which is arranged on both sides of the cavity of the oven,

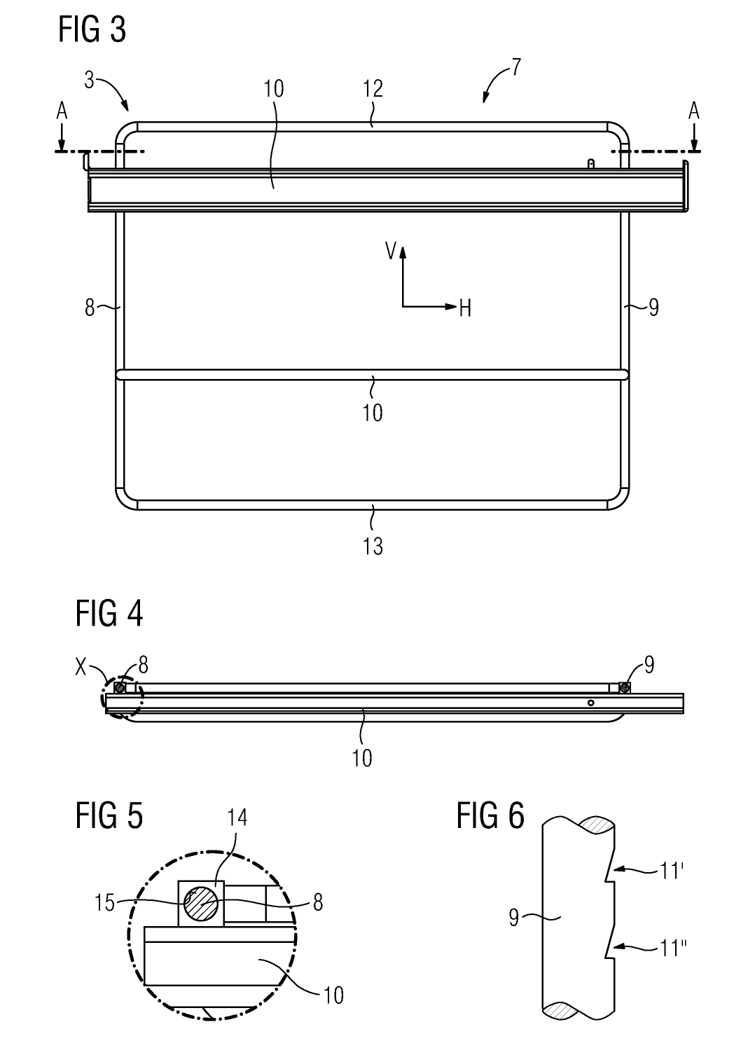

FIG. 3 shows the arrangement of FIG. 2 in the side view,

FIG. 4 shows the arrangement of FIG. 2 in the section A-A according FIG. 3, i.e. substantial in a top plan view,

FIG. 5 shows the detail “X” according to FIG. 4 and

FIG. 6 shows the view “A” according to FIG. 2 of a part of one of the columns. In FIG. 1 a domestic oven 1 is schematically shown having a cavity 2. On both sides 4 and 5 of the cavity 2 a carrier structure 3 is arranged. The carrier structures 3 are to hold an auxiliary element (not shown in FIG. 1), specifically a baking tray, in a desired height, i.e. in a desired position in vertical direction V.

The carrier structure 3 which is arranged in the sides 4, 5 of the cavity is shown in greater detail in FIG. 2 till FIG. 6.

The carrier structure 3 has a frame element 7 which holds a holding element 10 in a desired vertical height. More specifically, the carrier structure 3 has for purposes of illustration two different holding elements 10. It is already sufficient that only one of the holding elements 10 is used. If more holding elements 10 are employed, normally the same type of holding element 10 is used. Only for the purpose of explanation the frame element 7 is supplied with two different types of holding elements 10.

The frame element 7 is basically a closed loop of in total four sections, all made of a steel wire. Two vertical arranged columns 8 and 9 extend substantially along the entire vertical height of the cavity 2. The two columns 8, 9 are connected by connection rods 12 and 13 which run in horizontal direction H. As can be seen in FIG. 2 a quite simple holding element 10 (the lower one) can be arranged on the frame element 7 and more specifically on the two columns 8 and 9. For this the holding element 10 consists of a bended wire section which has bores at the ends which form a passage for the columns 8 and 9 respectively. As can be seen in FIG. 6 indexed positions 11′, 11″, . . . are machined into the columns 8 and 9 which form nose-like structures with constitute a stop for the holding element 10 in a definite vertical position. On the holding element 10 a baking tray 6 can be placed as shown with dashed lines in FIG. 2. The baking tray 6 is inserted from the front side of the oven 1 into the cavity 2 as usual.

It is also possible to employ a telescopic holding element 10 which is supported by the frame element 7. This is shown schematically in the upper part of FIG. 2 and FIG. 3. Here, a telescopic element is used as known for ovens to pull out and insert a baking tray form or into the cavity 2 without taking it from the frame element 7. Usual elements are used here, i.e. a suitable bearing element to allow a frictionless motion of a second part of the holding element (to be moved into horizontal direction H) relatively to a first part of the holding element (which is fixed with the frame element 7.

To allow an easy adjustment in vertical height the holding element 10 has two (or more) grip elements 14 which are fixed with the main body of the holding element. The grip element 14 has a bore 15 corresponding in shape with the cross section of the columns 8, 9.

The indexed positions 11′, 11″, . . . allow the right adjustment of the holding element 10 in the desired height in exactly the same height on both sides 4, 5 of the cavity 2 by the user in an easy way.

The adjustment of the vertical position of the holding element 10 can be done independently on both sides 4, 5 of the cavity 2.

### REFERENCE NUMERALS

1 Oven
2 Cooking cavity
3 Carrier structure
4 Side of the cavity
5 Side of the cavity
6 Auxiliary element (baking tray)
7 Frame element
8 Column
9 Column
10 Holding element
11′ Indexed position
11″ Indexed position
12 Connection rod
13 Connection rod
14 Grip element
15 Bore
V Vertical direction
H Horizontal direction

1-15. (canceled)

16. An oven, especially a domestic oven, comprising:
a cooking cavity and at least two carrier structures arranged at each side of the cavity respectively for holding an auxiliary element, in particular a tray or grid, for cooking good, in particular food;
wherein each carrier structure comprises at least one column, preferably at least two columns, extending in a vertical direction within the cavity and at least one holding element for holding the auxiliary element;
wherein the holding element is moveable along at least a sliding range of the column or columns in the vertical direction in a sliding movement, so that the holding element is adjustable in its vertical height within the cavity.

17. The oven according to claim 16, wherein the columns and the corresponding holding elements comprise corresponding guiding surfaces each extending in the vertical direction and being in contact with each other during the sliding movement so that, during the sliding movement, the holding element is guided by the column or columns.

18. The oven according to claim 16, having a cooking cavity, wherein:
a carrier structure is arranged at each side of the cavity for receiving and/or holding an auxiliary element; and
the carrier structure comprises a frame element having at least one vertical extending column on which a holding element is arranged adjustable in its vertical height relative to the column.

19. The oven according to claim 16, wherein the holding element can be fixed at each vertical position within the sliding range continuously, in particular by providing sufficient gripping or sliding resistance or by providing continuous fixation means such as gripping or clamping means at the holding element cooperating with the or at least one of the columns, in particular at or adjacent to the guiding surface of the column, which continuous fixation means can be released from the column(s) for allowing for the sliding movement and be fixed again when the sliding movement is over and the new vertical height is reached.

20. The oven according to claim 16, wherein:
the holding element can be fixed at several different vertical positions within the sliding range, in particular by providing positioning means which have at least one corresponding element provided at the or at least one of the columns at each of these different vertical positions;
in particular the positioning means comprise gripping means or clamping means or snapping means which can be released or the fixation of which can be reversibly overcome by applying a force above a certain holding threshold force for allowing for the sliding movement and be fixed again when the sliding movement is over and the new vertical position is reached.

21. The oven according to claim 20, wherein:
the positioning means comprise recesses in the column(s) at the different heights and a corresponding protruding part at the holding element snapping or engaging into the corresponding recess at a specified vertical position when the holding element during its vertical sliding movement reaches this specified vertical position; and/or
the at least one column has a plurality of indexed positions in different vertical heights for the holding element.

22. The oven according to claim 16, wherein:
the carrier structure has two connection rods, which connect two columns outside of the sliding range; and/or
the holding element is formed as a track or rod or rail and/or wherein the holding element extends in essentially horizontal direction; and/or
the holding elements are extraction elements such as telescopic runners with one fixed element being slideably held at or fixed to the columns and one or two further elements being horizontally and linearly moveable with respect to the other elements).

23. The oven according to claim 16, wherein the guiding surface has a constant shape in its horizontal cross section at least along the sliding range.

24. The oven according to claim 16, wherein two corresponding guiding surfaces at column and holding element have congruent or corresponding shapes in horizontal cross section at least along the sliding range.

25. The oven according to claim 16, wherein:
two corresponding guiding surfaces at column and holding element are arranged coaxially in vertical direction and/or are formed as closed surfaces or with closed contours in horizontal cross section, in particular a circular shape in horizontal cross section or a cylindrical shape as a whole;
in particular the guiding surfaces of the holding element are outside of the guiding surface of the column(s).

26. The oven according to claim 16, wherein two corresponding guiding surfaces at column and holding element are formed as open surfaces or with open contours in horizontal cross section, in particular open contours allowing for a shape-locked connection in horizontal direction such as T-shape or wedge-shape or drop-shape or the like.

27. The oven according to claim 16, wherein the holding element comprises at least one grip element which is fixed at the holding element and which has a bore for the passage of the column.

28. The oven according to claim 27, wherein the bore and the column have congruent forms in a horizontal cross section.

29. The oven according to claim 16, wherein the sliding range covers at least two, in particular all, predefined cooking levels within the cavity.

30. The oven according to claim 16, wherein the holding element during the sliding movement or in a fixed or adjusted vertical position is fixed in horizontal direction or remains at the same horizontal position with respect to or relative to the column(s) in horizontal direction relative remains at the column during adjustment of the height and there is only a vertical displacement.
